(19) United States
(12) Patent Application Publication
(10) Pub. No.: US 2022/0240481 A1
(43) Pub. Date: Aug. 4, 2022

(54) PET TRAINING PAD HAVING UPSTANDING BORDER

(71) Applicant: FOUR PAWS PRODUCTS, LTD., Neptune City, NJ (US)

(72) Inventors: Glen S. AXELROD, Colts Neck, NJ (US); Ajay GAJRIA, Holmdel, NJ (US); Diana M. ECHEVERRI, Beachwood, NJ (US)

(21) Appl. No.: 17/649,595

(22) Filed: Feb. 1, 2022

Related U.S. Application Data
(60) Provisional application No. 63/199,899, filed on Feb. 1, 2021.
(60) Provisional application No. 63/201,160, filed on Apr. 15, 2021.

(51) Int. Cl. A01K 1/015; A01K 1/01

(52) U.S. Cl. CPC A01K 1/0157; A01K 1/0107

(57) ABSTRACT

A pet training pad, comprising an absorbent region; and a border region surrounding at least a portion of the absorbent region including a deformable reinforcement disposed within the border region; wherein the border region including the deformable reinforcement is convertible from a substantially flat configuration to an upright configuration such that the border region including the deformable reinforcement converts from the substantially flat configuration to the upright configuration; and wherein, when the border region including the deformable reinforcement converts from the substantially flat configuration to the upright configuration, the deformable reinforcement bends from the substantially flat configuration to the upright configuration and the border region forms an upright wall.

### CROSS-REFERENCE TO RELATED APPLICATIONS

This application claims the benefit of U.S. provisional application No. 63/199,899 filed Feb. 1, 2021 and U.S. provisional application No. 63/201,160 filed Apr. 15, 2021, both of which are incorporated by reference, to the extent such is consistent with the present application.

### FIELD

The present disclosure generally relates to pet training pads that have a border that can be formed as to be upright by the user. More specifically, the present disclosure relates to pet training pads that have one or more border regions that can be folded or otherwise manipulated to convert the pet training pad from a substantially flat configuration to a deployed configuration with one or more upright border regions.

### BACKGROUND

Pet owners often housetrain pets such that the pet does not urinate and/or defecate at an undesirable location within the owner's home. For example, dog owners often train their dog to urinate and/or defecate outside the owner's home. In some situations, however, a dog or other pet may not be able to go outside when it needs to use relieve itself. To address such situations, a pet owner may train their pet to urinate and/or defecate at a consistent location within their home. For example, a pet owner may train a dog or other animal to urinate/defecate on an absorbent pet training pad that is placed at a desired location in the home. Such pet training pads are configured to protect underlying surfaces from urine and feces, and are often configured such that the owner can easily clean up and dispose of them once they are soiled.

While pet training pads are widely utilized and can be effective, such pads are generally configured to lay substantially flat on an underlying surface such as a floor. When an animal uses such a pad, the animal may position itself such that urine and feces are not directed to the center of the pad, but rather towards a periphery of the pad. As a result, animal waste (particularly urine) may flow off the pad before it is absorbed by the pad. The resulting mess is inconvenient and unappealing to clean up, and may cause damage to surfaces around the pad. Thus, there remains a need in the art for pet training pads that can better contain animal waste (particularly urine) within the dimensional confines of the pad.

### SUMMARY

A pet training pad, comprising an absorbent region and at least one border region surrounding at least a portion of the absorbent region, the border region including a reinforcement. The border region, including the reinforcement, can be folded or otherwise manipulated from a substantially flat (e.g. horizontal) configuration to a deployed configuration, wherein the border region, including the reinforcement, is arranged as an upright (e.g. vertical) border region.

### BRIEF DESCRIPTION OF THE DRAWINGS

Features and advantages of this disclosure will become more apparent as the following detailed description proceeds, and upon reference to the drawings, wherein like numerals designate like parts, and in which:

FIG. 1A is a front side (plan) view of an exemplary pet training pad of the present disclosure, in a substantially flat state.

FIG. 1B illustrates the pet training pad of FIG. 1A with one folded border region.

FIG. 1C illustrates the pet training pad of FIG. 1A with two folded border regions.

FIG. 1D illustrates the pet training pad of FIG. 1A in a fully deployed state.

FIG. 1E illustrates the pet training pad of FIG. 1A in a close-up view.

FIG. 1F illustrates the pet training pad of FIG. 1C in a close-up view.

FIG. 1G illustrates a cross-section of right border region of the pet training pad of FIG. 1C taken along line 1G-1G.

FIG. 1H illustrates the right border region of the pet training pad of FIG. 1D taken along line 1H-1H.

FIG. 2 is a photograph of the pet training pad of FIGS. 1A-1F in the fully deployed state.

FIG. 3 is a front side (plan) view of another exemplary pet training pad of the present disclosure, in a substantially flat state.

FIG. 4 is a front side (plan) view of another exemplary pet training pad of the present disclosure, in a substantially flat state.

FIG. 5 is an exploded perspective view of an exemplary absorbent region of a pet training pad of the present disclosure.

FIG. 6A is a front side (plan) view of another exemplary pet training pad of the present disclosure, in a substantially flat state.

FIG. 6B is a back side (plan) view of the exemplary pet training pad of FIG. 6A.

FIG. 6C illustrates folding operations on the pet training pad of FIGS. 6A and 6B.

FIG. 6D illustrates the pet training pad of FIGS. 6A-6C in a fully deployed state.

FIG. 7 is a photograph of the pet training pad of FIGS. 6A-6D in a fully deployed state.

### DETAILED DESCRIPTION

As noted in the background, pet training pads are currently known. Although such pads can be effective, they typically are configured to lie substantially flat on an underlying surface such as a floor. When an animal uses the pad, the animal may position itself so that urine and feces are deposited relatively close to a periphery of the pad, rather than at the center of the pad. Consequently, urine and/or feces may run off the pad, soiling and potentially damaging surfaces around the pad.

With the foregoing in mind, the present disclosure generally relates to pet training pads that include one or more border regions which may initially be arranged substantially flat, and subsequently deployed as to be upright. More particularly, the pads may be initially provided in a substantially flat state, i.e., a state in which the one or more border regions of the pad lie substantially in the plane of an absorbent region of the pad when the pad is in the substantially flat state and is positioned on a flat surface such as a floor. Each of the one or more border regions has an inner edge and an outer edge, wherein the inner edge is located at an interface between the border region and the absorbent region, respectively. One or more reinforcements, such as one or more flexible, resilient (deformable/malleable) wires, may preferably be positioned and extend along (e.g. adjacent) the inner edge of the one or more of the border regions. Preferably, such reinforcements are placed along at least the inner edges of two opposing border regions. The reinforcements each include a body portion and at least one end portion. Each end portion is configured such that, when a border region is folded or otherwise manipulated toward the absorbent region of the pad, the border region, including the end portion of the reinforcement, is arranged as an upright (vertical) border region (with the reinforcement bent upwards) relative to the substantially flat (horizontal) absorbent region. Thus, by folding or otherwise manipulating the border region(s) and the end portions, one or more of the border regions may be converted into a side (vertical) wall that extend upwards relative to the (horizontal) absorbent region. The side (vertical) wall(s) preferably act as a barrier to prevent passage of animal waste—particularly urine—and thus may function to contain the waste within the dimensional confines of the pad even if the waste is deposited by the animal relatively close to the side (vertical) wall(s).

In those or other embodiments the pet training pads described herein may have a front side and a back side. In such embodiments the pet training pads may include one or more border regions that lie substantially in the plane of an absorbent region of the pad when the pad is in a substantially flat state and is placed on a flat surface such as a floor. Each of the one or more border regions has an inner edge and an outer edge, wherein the inner edge is located at an interface between the border region and the absorbent region, respectively. One or more adhesive members may be positioned on the back side of the pet training pad, wherein each adhesive member is located proximate a respective corner of a border region of the pet training pad. The adhesive member(s) may face downward when the pet training pad is in the substantially flat state and is placed back side down on a surface. In such embodiments, when two of the border regions are folded or otherwise manipulated towards the absorbent region in accordance with respective first and second folding operations, the adhesive member(s) on the back side of the border region are oriented to face generally upwards and the front side of the folded border region(s) is oriented to face generally downwards. Subsequently, third and fourth folding operations may be performed such that a first portion of each adhesive member adheres to a second portion of the (same) adhesive member, resulting in the formation of supports that causes at least a portion of a border region to extend (vertically) upright relative to the substantially flat (horizontal) absorbent region. Thus, by folding or otherwise manipulating the border regions, the adhesive members may be converted into supports and one or more of the border regions may be converted into a side (vertical) wall that extends upwards relative to the absorbent region. As before, the side (vertical) wall(s) preferably act as a barrier to prevent passage of animal waste—particularly urine—and thus may function to contain the waste within the dimensions of the pad even if the waste is deposited by the animal relatively close to the side (vertical) wall(s).

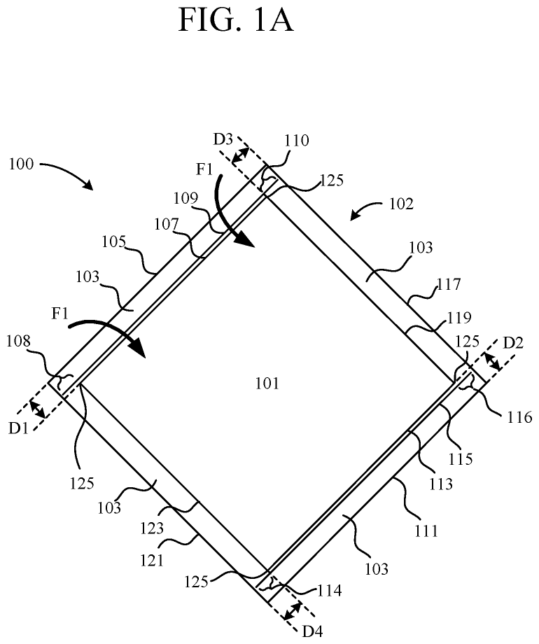

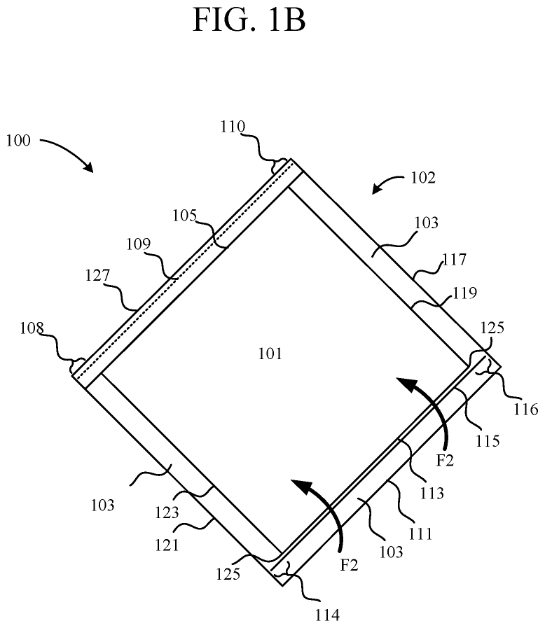

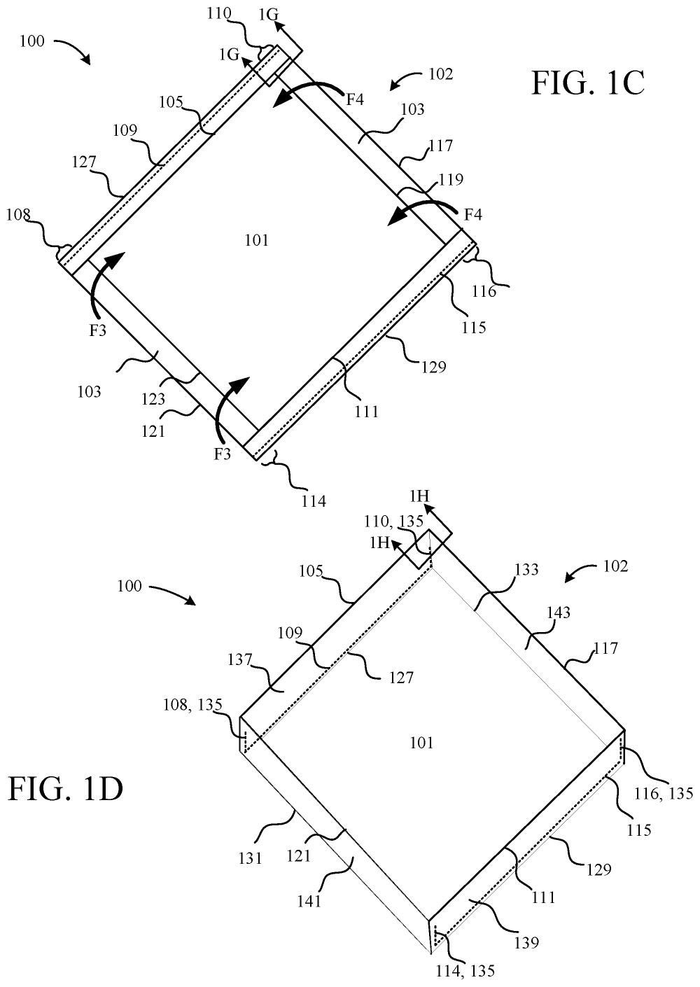

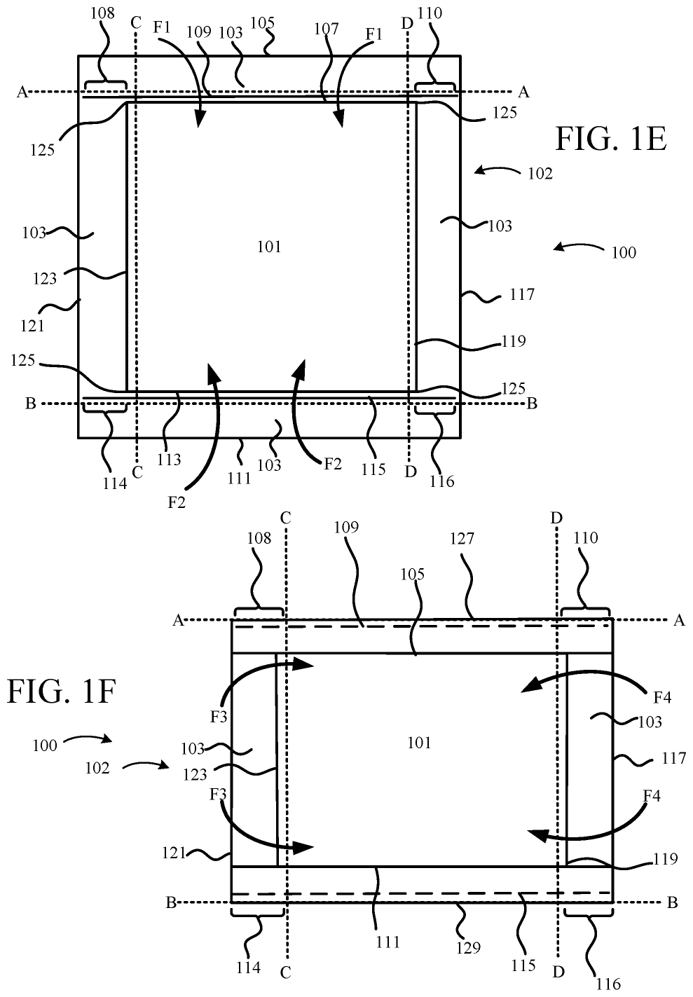

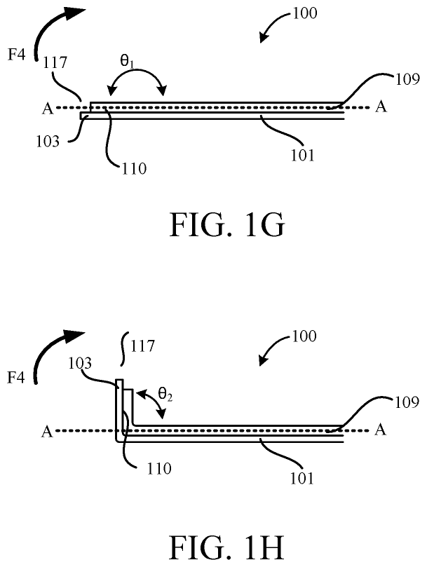

FIGS. 1A-1H illustrate an exemplary pet training pad 100 according to the present disclosure. Pad 100 may be initially in a substantially flat (e.g. horizontal when placed on a horizontal floor) state, as shown in FIGS. 1A and 1E. Pad 100 may be converted to a deployed state as shown in FIG. 1D, e.g., by manipulating the pad 100, such as by performing folding or other manipulating operations that include at least deforming (e.g. bending) (horizontal) end portions of one or more resilient (deformable/malleable) reinforcements 109, 115 within the pad 100, to form (vertical) uprights 135 that convert/raise one or more (horizontal) border regions 103 of the pad 100 into one or more upright (vertical) border regions 103 forming upright (vertical) walls extending vertically upwards relative to a (horizontal) absorbent region 101 of the pad 100.

As best shown in FIGS. 1A and 1E, pad 100 includes a pad body 102 having an absorbent region 101 and one or more border regions 103. The absorbent region 101 is generally configured to absorb or otherwise retain animal waste, such as urine or feces. The nature and construction of absorbent region 101 is not limited, and absorbent region 101 may be constructed in any suitable manner. In one or more embodiments, absorbent region 101 includes at least one material layer that is configured to absorb liquid such as urine. In one or more embodiments, the absorbent region 101 includes an absorbent layer, either alone or in combination with one or more other material layers. For example, in one or more embodiments, the absorbent region 101 may include an attractant layer designed to attract an animal via an odor or other stimulant, an absorbent layer, and an odor control layer to mask/cover up odors. Such layers may be provided on a fluid impervious backing layer in any suitable order.

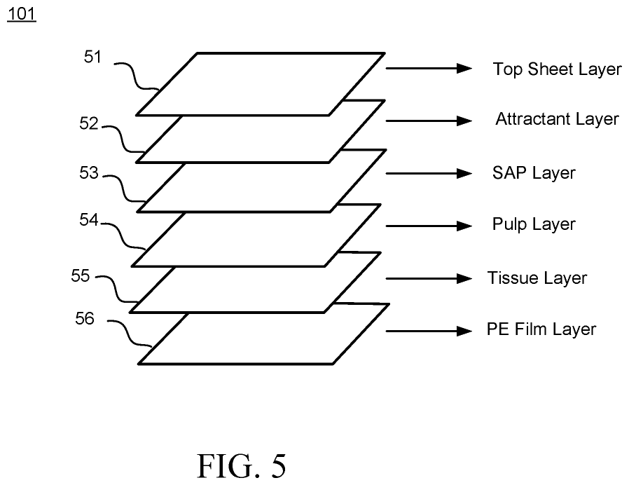

For example, and as illustrated in FIG. 5, absorbent region 101 may include a top sheet layer 51 (which faces the animal) that is designed to be porous to liquid waste. This may then be followed by an attractant layer 52 which is designed to attract the animal via smell or another stimulant, and an absorbent layer 53. It should also be appreciated that, optionally, additional layers may be present, such as an odor control layer or a scent layer which would mask or cover-up odors occurring after use.

The absorbent layer 53 may more particularly be a superabsorbent polymer (SAP) layer, which may preferably be formed of a superabsorbent polymer, having, for example, a retention absorbency in a range of 30 g/g to 45 g/g, an absorption capacity in a range of 55 g/g to 65 g/g (as measured in a 0.9% NaCl aqueous solution), an absorptive rate (e.g., a quantity of time to absorb 50, 100, or 150 milliliters of liquid such as a 0.9% NaCl aqueous solution) in a range of 15 seconds to 40 seconds, a moisture content in a range of 4% to 9%, a measure of residual acrylic acid monomers in a range of 15 parts-per-million (ppm) to 25 ppm, and a bulk density in a range of 0.6 g/ml to 0.85 g/ml. By way of further example, the absorbent layer 53 may be formed of a superabsorbent polymer having a retention absorbency of 41 g/g, an absorption capacity of 60 g/g (as measured in a 0.9% NaCl aqueous solution), an absorptive rate of 29 seconds, a moisture content of 7.4%, a measure of residual acrylic acid monomers of 22 ppm, and a bulk density of 0.74 g/ml. By way of still further example, the absorbent layer 53 may be formed of a superabsorbent polymer having a retention absorbency of 40 g/g, an absorption capacity of 60 g/g (as measured in a 0.9% NaCl aqueous solution), an absorptive rate of 30 seconds, a moisture content of 7.2%, a measure of residual acrylic acid monomers of 18 ppm, and a bulk density of 0.74 g/ml. Particle sizes of the superabsorbent polymer forming the absorbent layer 53, and more particularly the superabsorbent polymer layer, may measure less than 850 microns (μm). For example, between 80% and 90% of the particles may have a particle size measuring in a range of 180 μm to 500 μm.

As further shown absorbent region 101 may further include a pulp layer 54. The pulp layer 54 may be formed by pulp fibers and/or pulp powder that is distributed within the pulp layer 54 as illustrated. This may then be followed by a tissue layer 55 which preferably comprises of tissue paper. This may then be followed by a film layer 56, and more particularly a continuous film layer 56 (i.e. does not have any perforations which would allow waste fluid (e.g. urine) to pass through the layer 56). The film layer 56 may be a polyolefin type film layer, such as a polyethylene film layer. In any case, film layer 56 is preferably formed from or includes an impermeable film that prevents the flow of waste fluid from contacting the floor or other surface upon which the absorbent pad 100 may be placed.

Border region 103 is generally configured to indicate an end of absorbent region 101. Without limitation, in one or more embodiments, the border region 103 is preferably in the form of the film layer 56 (which includes a polyolefin film, such as but not limited to a polyethylene film), but without at least the absorbent layer 53, and preferably without one or more, or all, of the top sheet layer 51, the attractant layer 52, the pulp layer 54 and the tissue layer 55. Without limitation, in one or more embodiments, border region 103 is a continuation of the film layer 56 used in absorbent region 101, such as by not limited to a portion of the film layer 56 that extends past the boundary of absorbent region 101. The material of border region 103 is preferably flexible or pliable, such that the border region 103 is foldable or otherwise manipulatable to be repositioned from a substantially flat state to an upright state.

In the embodiment of FIGS. 1A-1F, pad 100 is depicted as having an overall polygonal, and more particularly a quadrilateral shape and as including a quadrilateral absorbent region 101 continuously surrounded (i.e. 360 degrees) by a “picture (annular) frame” border region 103. However, the pads 100 described herein are not limited to such a configuration, and may have any suitable shape. For example, pad 100 may have an overall shape that has any suitable number of sides, such as 1, 2, 3, 4, 5, 6, 7, 8, 9, 10 or more sides. Likewise, absorbent region 101 may have any suitable number of sides, and in one or more embodiments, absorbent region 101 has a number of sides that is the same as or different from the number of sides of pad 100. Preferably, absorbent region 101 has the same number of sides as pad 100, wherein the sides of pad 100 are defined by outer edges of border region 103.

Pad 100 is also shown with an absorbent region 101 that includes four corners 125 (i.e., a first corner, second corner, third corner, and fourth corner). Such a configuration is not required, and absorbent region 101 may be configured differently. Indeed, absorbent region 101 may have any suitable geometry, with no corners or greater than 0 (zero) corners (i.e. one or more corners). Each border region 103 may be adjacent to each side of absorbent region 101, and includes at least one inner and outer edge. For example, and as further shown in FIGS. 1A and 1E, border region 103 includes a top outer edge 105, a top inner edge 107, a bottom outer edge 111, a bottom inner edge 113, a right outer edge 117, a right inner edge 119, a left outer edge 121, and left inner edge 123. Top and bottom inner edges 107, 113 extend laterally along corresponding top and bottom sides of absorbent region 101, and right and left inner edges 119, 123 extend vertically along corresponding right and left sides of absorbent region 101, respectively. In this embodiment the top, bottom, left, and right sides of absorbent region 101 extend between a respective two corners 125 of absorbent region 101.

As used herein, the term “inner edge” is used to describe a boundary between an edge of the absorbent region 101 and the border region 103. In one or more embodiments, each inner edge 107, 113, 119, 123 of border region 103 is defined by an edge of the material forming border region 103. In one or more embodiments, the border region is defined by part of a fluid impervious film (backing) layer 56 that extends past the edge of absorbent region 101. In such instances the inner edges 107, 113, 119 123 of border region 103 are not defined by an end edge of the material forming border region 103, but rather are an interface at which the material of border region 103 is adjacent to the edges of absorbent region 101.

For the sake of illustration and ease of understanding, top outer edge 105, bottom outer edge 111, right outer edge 117, and left outer edge 121 have been illustrated as linearly extending substantially parallel to corresponding top inner edge 107, bottom inner edge 113, right inner edge 119, and left inner edge 123, respectively. Such a configuration is not required and outer edges 105, 111, 117, and 121 may have any suitable shape. In one or more embodiments, outer edges 105, 111, 117, and 121 are preferably offset from inner edges 107, 113, 119, and 123, respectively, and a have a linear, curvilinear, stepped, or other shape.

Top outer edge 105 may be offset from top inner edge 107 by a first distance D1, bottom outer edge 111 may be offset from bottom inner edge 113 by a second distance D2, right outer edge 117 may be offset from right inner edge 119 by a third distance D3, and left outer edge 121 may be offset from left inner edge 123 by a fourth distance D4. D1-D4 may be defined as the linear distance between two opposing points on corresponding inner and outer edges, and may range from greater than 0 (zero) to about 3 inches, such as from greater than 0 (zero) to about 2.5 inches, or even from about 0.2 to about 2.3 inches. In embodiments D1, D2, D3, and D4 are each preferably in a range of about 0.2 to about 2.2 inches. In any case, D1-D4 may be the same or different from one another. Without limitation, D1, D2, D3, and D4 are the same or at least about the same.

Pad 100 further includes a first reinforcement 109 and a second reinforcement 115, which may each be in a form of an elongated member (preferably as an extrudate via profile extrusion), which are bonded to the pad body 102 continuously over their longitudinal lengths. In general, the first and the second reinforcements 109, 115 are flexible, resilient (deformable/malleable) members that can be deformed (e.g. bent) vertically upwards relative to absorbent region 101 to provide one or more vertical uprights. When deformed, such uprights cause at least a portion of horizontal border region 103 to extend vertically upwards relative to absorbent region 101, whereby the horizontal border region 103 converts to an upright (vertical) border region 103 that surround at least a portion of the absorbent region 101 when pad 100 is in a deployed state. More particularly, each of the first and second reinforcements 109, 115 can be bent to provide a plurality of uprights (i.e., two or more) that cause a portion of horizontal border region 103 there between to convert to an upright (vertical) border region 103 providing an upright (vertical) wall that extends upwards relative to absorbent region 101.

First and second reinforcements 109, 115 may be configured in any suitable manner and may be made of any suitable material. In embodiments first and second reinforcements 109, 115 are in each in the form of a flexible resilient (deformable/malleable) member, i.e., an object which may be provided in a first shape and bent to form and retain a second shape. Non-limiting examples of suitable flexible resilient (deformable/malleable) members that may be used first and second reinforcements 109, 115 include wires, ribbons, sheets, ropes, cables, ties, combinations thereof, and the like, which may be made from one or more metals, alloys, plastics, composite materials, combinations thereof, and the like.

Without limitation first and second reinforcements 109, 115 are preferably in the form of or include plastic, metal, or alloy wires, and in specific non-limiting embodiments first and second reinforcements 109, 115 are formed from plastic. When wire is used a reinforcement herein, the wire may have any suitable cross-sectional shape, such as a round (e.g., circular), non-circular, polygonal, or other cross-sectional shape. Without limitation, a wire with a round or circular cross section is preferably used as the reinforcements described herein. In any case, the wire may have a diameter or largest cross-sectional thickness in the range of 0.5 to 10 millimeters (mm). Without limitation, the reinforcements described herein are formed from or include a wire with a diameter or largest cross section thickness in the range of 2 to 4 mm.

When pad 100 is in a substantially flat state (FIGS. 1A and 1E), first and second reinforcements 109, 115 are disposed within the thickness of their corresponding border region 103 and preferably extend at least substantially parallel to top inner edge 107 and bottom inner edge 113, respectively. More specifically, first and second reinforcements 109, 115 are preferably positioned such that all, or substantially all, extend parallel, or substantially parallel, to their respective top inner edge 107 and bottom inner edge 113 for all or substantially all of their length.

First and second reinforcements 109, 115 each include a body portion and at least one end portion. The body portion of first and second reinforcements 109, 115 is the portion thereof that extends at least substantially coextensively with at least a portion of the top inner edge 107 and bottom inner edge 113 respectively, i.e., between respective corners 125 of absorbent region 101. The end portions of first and second reinforcements 109, 115 are the portions thereof that preferably extend beyond a respective corner 125 of absorbent region 101. For example, in FIGS. 1A and 1E, first reinforcement 109 includes a first end portion 108 and a second end portion 110 that each preferably extend past a corresponding corner 125 of the top side of absorbent region 101. Likewise, second reinforcement 115 includes a third end portion 114 and a fourth end portion 116 that each extend past a corner 125 of the bottom side of absorbent region 101.

The length of the end portions 108, 110, 114, 116 generally corresponds to the degree to which first and second reinforcements 109, 115 extend past a corner 125 of absorbent region in the substantially flat state (i.e. the length of the end portions). With that in mind, the length of end portions 108, 110, 114, 116 is not limited. In one or more embodiments, the length of the end portions 108, 110, 114, 116 may be the same or different, and may range from greater than 0 (zero) to less than or equal to the width (i.e. distance D3 or D4) of the border region 103 into which the end portion 108, 110, 114, 116 extends. For example, the length of the end portions 108, 110, 114, 116 each range from greater than 0 to about 3 inches, such as from greater than 0 to about 2.5 inches, from greater than or equal to about 0.2 to about 2.3 inches, or even from about 0.2 to about 2.2 inches. Θ₂

[symbol]

In one or more embodiments, when pad 100 is in a substantially flat state, the length of first and second end portions 108, 110 is within the above ranges and the end of first and second end portions 108, 110 are each located from greater than 0 (zero) to about 1 inches (e.g., from greater than 0 to about 0.5 inches or even from greater than 0 (zero) to about 0.25 inches) away from an opposing point on left outer edge 121 and right outer edge 117, respectively. In those or other embodiments, when pad 100 is in a substantially flat state the length of third and fourth end portions 114, 116 is within the above ranges, and the end of third and fourth end portion 114, 116 are each located from greater than 0 to about 0.5 inches (e.g., from greater than 0 to about 0.25 inches) away from an opposing point on left outer edge 121 and right outer edge 117, respectively.

Pad 100 may transition from the substantially flat state shown in FIGS. 1A and 1E to the deployed state shown in FIG. 1D by folding the border region 103 towards absorbent region 101. More specifically and as shown in FIGS. 1A-1C and 1E-1F, pad 100 may be transitioned to the deployed state shown in FIG. 1D by executing folding operations F1, F2, F3, and F4. The order in which such folding operations is not limited, but the outcome of such operations may be enhanced by performing them in the order of F1 to F4, as shown and described below.

Specifically, and as best shown in FIGS. 1A and 1E, a first fold F1 may be performed by pulling the top outer edge 105 towards the absorbent region 101 and folding a first portion of the border region 103 along and across a first folding axis A-A that extends at least substantially parallel to top inner edge 107 and along a portion of border region 103. During the first fold F1, a first crease 127 may be formed along the first folding axis A-A. Following the first fold F1, the horizontal border region 103 that includes the top outer edge 105 may extend vertical upwards relative to the absorbent region 101 and create a vertical border region 103 forming upright vertical wall 137 as shown in FIG. 1D, and/or may be at least partially disposed over at least a portion of the absorbent region 101, as best shown in FIGS. 1B, 1C, and 1F.

Before or after the first fold, a second fold F2 may be performed by pulling bottom outer edge 111 towards the absorbent region 101 and folding a second portion of the border region 103 along and across a second folding axis B-B that extends at least substantially parallel to bottom inner edge 113 and along and across a portion of border region 103, as best shown in FIGS. 1B and 1E. During the second fold F2, a second crease 129 may be formed along the second folding axis B-B. FIG. 1F. Following the second fold F2, the horizontal border region 103 that includes bottom outer edge 111 may extend vertical upwards relative to the absorbent region 101 and create a vertical border region 103 forming upright vertical wall 139 as shown in FIG. 1D, and/or may be at least partially disposed over at least a portion of the absorbent region 101, as best shown in FIGS. 1C and 1F.

Following the first and second folds F1, F2, third and fourth folds F3 and F4 may be performed as shown in FIGS. 1C and 1F. During the third fold F3, left outer edge 121 is pulled towards absorbent region 101 and a third portion of the border region 103 is folded along and across a third folding axis C-C, at which time the first and third end portions 108, 114 are deformed (bent) vertically upwards relative to the horizontal absorbent region 101(i.e. transverse to the longitudinal axis and the body portions of the reinforcement 109, 115 respectively) to covert/raise the horizontal border region 103 into an upright vertical border region 103 forming upright vertical wall 141. Likewise, during the fourth fold F4, right outer edge 117 is pulled towards absorbent region and a fourth portion of the border region 103 is folded along and across a fourth folding axis D-D, at which time the second and fourth end portions 110, 116 are bent vertically upwards relative to the horizontal absorbent region 101 (i.e. transverse to the longitudinal axis and the body portions of the reinforcement 109, 115 respectively) to covert/raise the horizontal border region 103 into an upright vertical border region 103 forming an upright vertical wall 143. During the third and fourth folds F3 and F4, third and fourth creases 131, 133 may be formed along the third and fourth folding axes C-C and D-D, respectively.

As best shown in FIG. 1D, following the third and fourth folds, end portions 108, 110, 114, 116 each form uprights 135 that extend upwards relative to absorbent region 101 which support the border region 102 in its vertical orientation. The length of each upright 135 is preferably less than or equal to the length of corresponding end portions 108, 110, 114, 116. Because border region 103 is formed from a flexible/pliable material, when end portions 108, 110, 114, and 116 are bent vertically upwards during folding operations F1-F4 to form uprights 135, at least a portion of the border region 103 is urged vertically upwards relative to horizontal absorbent region 101. As a result, portions of border region 103 are urged vertically upwards relative to horizontal absorbent region 101 to form at least one vertical wall.

For example, and as shown in FIG. 1D, vertical uprights 135 formed by end portion 108 and end portion 114 cause a portion of border region 103 that includes left outer edge 121 to be urged to extend vertically upwards relative to horizontal absorbent region 101 and form vertical wall 141. Similarly, uprights 135 formed by end portion 110 and end portion 116 cause a portion of border region 103 that includes right outer edge 117 to be urged to extend upwards relative to horizontal absorbent region 101 and form vertical wall 143. Upon the formation of walls 141, 143, if the portion of the border region 103 that includes top outer edge 105 is at least partially disposed over (i.e. overlies) at least a portion of the absorbent region 101, particularly as to be substantially flat with the horizontal absorbent region 101, such may be partially unfolded such that the horizontal border region 103 that includes the top outer edge 105 may extend vertical upwards relative to the absorbent region 101 and create a vertical border region 103 forming upright vertical wall 137 as shown in FIG. 1D. Similarly, if the portion of the border region 103 that includes bottom outer edge 115 is at least partially disposed over (i.e. overlies) at least a portion of the absorbent region 101, particularly as to be substantially flat with the horizontal absorbent region 101, such may be partially unfolded such that the horizontal border region 103 that includes the bottom outer edge 111 may extend vertical upwards relative to the absorbent region 101 and create a vertical border region 103 forming upright vertical wall 139 as shown in FIG. 1D. In such regards, the uprights 135 formed by end portions 108, 110 may support a portion of border region 103 that includes top outer edge 105 to extend upwards relative to absorbent region 101 and form wall 137, while the uprights 135 formed by end portions 114, 116 may support a portion of border region 103 that includes bottom outer edge 111 to extend upwards relative to absorbent region 101 and form wall 139.

Referring briefly to FIGS. 1G-1H, the fourth portion of the border region 103 is shown in a substantially flat (horizontal) state prior to fold F4 in FIG. 1G, and shown in an upright (vertical) state after fold F4 in FIG. 1H. Prior to folding or being deployed, the angle θ₁ formed between the substantially flat (horizontal) absorbent region 101 and the substantially flat (horizontal) boarder 103 may be in a range, for example, of 150 degrees to 210 degrees (shown as 180 degrees). After folding or after being deployed, the angle θ₂ formed between the substantially flat (horizontal) absorbent region 101 and the upright (vertical) border 103 (which may also be referred to as vertical wall 143) may be in a range, for example, of greater than 45 degrees and less than 135 degrees (shown at 90 degrees). More particularly, after folding or after being deployed, the angle 02 formed between the substantially flat (horizontal) absorbent region 101 and the upright (vertical) boarder 103 may be in a range, for example, of 48 degrees to 132 degrees. Even more particularly, after folding or after being deployed, the angle θ₂ formed between the substantially flat (horizontal) absorbent region 101 and the upright (vertical) boarder 103 may be in a range, for example, of 60 degrees to 120 degrees. Even more particularly, after folding or after being deployed, the angle θ₂ formed between the substantially flat (horizontal) absorbent region 101 and the upright (vertical) boarder 103 may be in a range, for example, of 70 degrees to 110 degrees. Even more particularly, after folding or after being deployed, the angle θ₂ formed between the substantially flat (horizontal) absorbent region 101 and the upright (vertical) boarder 103 may be in a range, for example, of 80 degrees to 100 degrees. Even more particularly, after folding or after being deployed, the angle θ₂ formed between the substantially flat (horizontal) absorbent region 101 and the upright (vertical) boarder 103 may be in a range, for example, of 85 degrees to 95 degrees. The foregoing should be understood to apply equally to all upright border regions/vertical walls 137, 139, 141, 143 disclosed herein and for all embodiments.

In the embodiment of FIGS. 1A-1F, first and second fold axes A-A and B-C are each depicted as extending parallel and tangential (adjacent) to top inner edge 107 and bottom inner edge 111, respectively, and over at least a portion of border region 103. Similarly, the third and fourth fold axes C-C and D-D are each depicted as extending parallel and tangential (adjacent) to left inner edge 123 and right inner edge 119, respectively, and over at least a portion of absorbent region 101. However, it should be understood that such a configuration is not required, and folding axes A-A, B-B, C-C, and D-D may be positioned differently, resulting in a corresponding difference in the position of a folded edge/crease following execution of the first, second, third, and/or fourth folds F1, F2, F2, and F4. For example, as shown, first and second fold axes A-A and B-B may extend only over a portion of border region 103, and may be positioned at any suitable distance relative to top inner edge 107 and bottom inner edge 113, respectively. In contrast, third and fourth fold axes C-C and D-D may extend over the absorbent region 101 as well as a portion of border region 103, and may be positioned at any suitable distance relative to left inner edge 123 and right inner edge 119, respectively. As may be appreciated, the position of the folding axes A, B, C, and D can affect various characteristics of walls 137, 139, 141, 143, such as but not limited to their height and ability to remain upright relative to absorbent region 101. Accordingly, the position of folding axes A, B, C, and D and the performance of corresponding first, second, third, and fourth folding operations may be tailored to obtain walls 137, 139, 141, and 143 with desired characteristics.

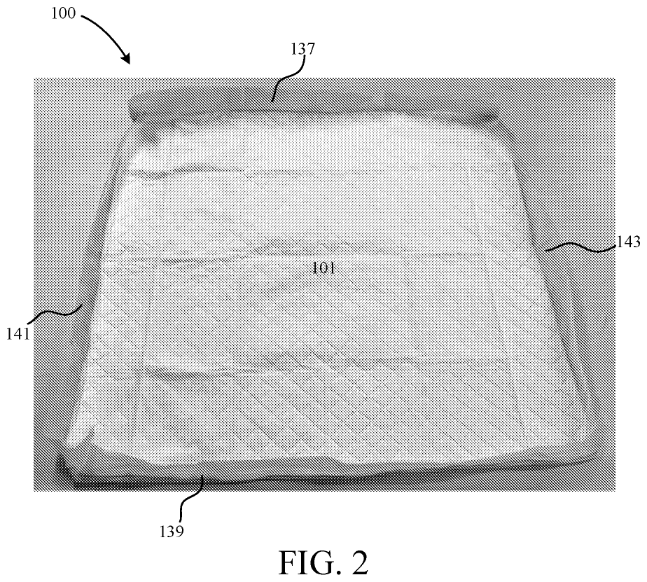

FIG. 2 is a photograph of one example of a pad 100 in the deployed state. As shown, pad 100 includes first, second, third, and fourth walls 137, 139, 141, 143 that can remain upright relative to absorbent region 101 even when only two reinforcements 109, 115 are used. As may be appreciated, this can facilitate manufacturing of pads 100 as reinforcements 109, 115 may be introduced into border region 103 as the material of border region 103 moves in the machine direction during forming of pad 100.

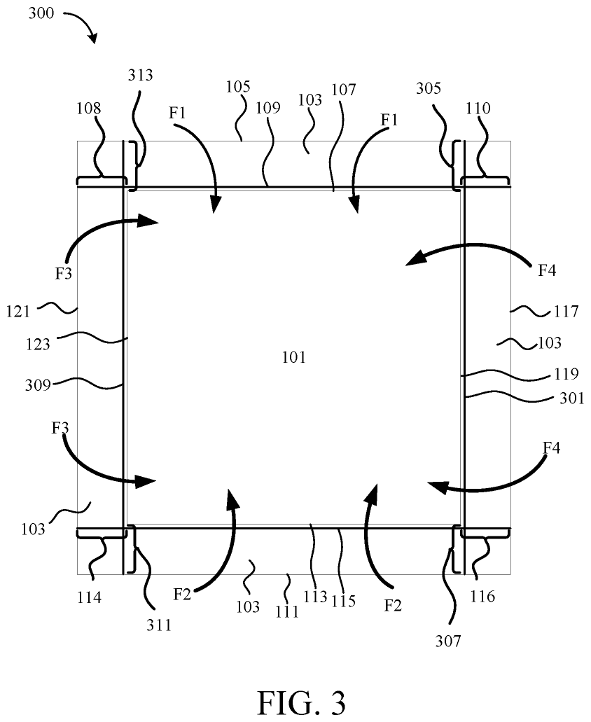

FIG. 3 illustrates another example of a pad 300 consistent with the present disclosure, in a substantially flat state. As shown, pad 300 includes many of the same components of pad 100. As the nature and function of such components is the same as described above in connection with pad 100, such components are not described again in detail. With that in mind, pad 300 principally differs from pad 100 in that it includes additional reinforcements. Specifically, pad 300 includes third reinforcement 301 and fourth reinforcement 309. Third reinforcement 301 is disposed within a thickness of the border region 103 and extends parallel or substantially parallel to the right inner edge 119. Similarly, fourth reinforcement 309 is disposed within a thickness of border region 103 and extends parallel or substantially parallel to left inner edge 123.

Like first and second reinforcements 109, 115, third and fourth reinforcements 301, 309 include body portions and end portions. The body portions of third and fourth reinforcements 301, 309 are the portions thereof that extend at least substantially coextensively with at least a portion of right inner edge 119 and left inner edge 123, respectively, i.e., between respective corners 125 of absorbent region 101. The end portions of third and fourth reinforcements 301, 309 are the portions thereof that extend beyond a respective corner 125 of absorbent region 101.

In FIG. 3, third reinforcement 301 includes a fifth end portion 305 and a sixth end portion 307 that each extend past a corresponding corner 125 of the right edge of absorbent region 101. Likewise, fourth reinforcement 309 includes a seventh end portion 311 and an eighth end portion 313 that each extend past a corner 125 of the left edge of absorbent region 101. In the illustrated embodiment, third and fourth reinforcements 301, 309 are oriented perpendicular to first and second reinforcements 109, 115, i.e., such that their respective end portions form a right angle. Such a configuration is for the sake of example only and is not required, and first, second, third, and fourth reinforcements 109, 115, 301, 309 may be oriented differently. For example, first, second, third and fourth reinforcements 109, 115, 301, and 309 may be oriented such that an angle between their respective end portions (i.e., end portions proximate an intersection of two reinforcements) ranges from greater than 0 to less than 360 degrees, such as from greater than 0 to about 180 degrees, greater than 0 to about 120 degrees, greater than 0 to about 90 degrees, or even greater than 0 to about 45 degrees. In embodiments the angle between respective end portions of first-fourth reinforcements is about 90 degrees. In other embodiments the angle between respective end portions of first-fourth reinforcements 109, 115, 301, 309 is about 45 degrees. As may be appreciated, the angle between respective end portions of the first-fourth reinforcements 109, 115, 301, 309 may be set to adjust the position of uprights 135 formed by such end portions when pad 300 is converted to a deployed position, with a corresponding change in the support of walls 137, 139, 141, 143 formed by portions of border region 103.

The length of the end portions 305, 307, 311, 313 generally corresponds to the degree to which third and fourth reinforcements 301, 309 extend past a corner 125 of absorbent region in the substantially flat state (i.e. the length of the end portions). With that in mind, the length of end portions 305, 307 311, 313 is not limited. In embodiments, the length of the end portions 305, 307 311, 313 may be the same or different, and is within the ranges specified above in connection with end portions 108, 110, 112, and 114.

In embodiments, when pad 100 is in a substantially flat state the length of fifth and sixth end portions 305, 307 is within the ranges noted above and the end fifth and sixth end portions 305, 307 are each located from greater than 0 to about 0.5 inches (e.g., from greater than 0 to about 0.25 inches) away from an opposing point on top outer edge 105 and bottom outer edge 111, respectively. In those or other embodiments, when pad 100 is in a substantially flat state the length of seventh and eighth end portions 311, 313 is within the above ranges, and the end of seventh and eighth end portions 311, 313 are each located from greater than 0 to about 0.5 inches (e.g., from greater than 0 to about 0.25 inches) away from an opposing point on top outer edge 105 and bottom outer edge 111, respectively.

Pad 300 may transition from the substantially flat state shown in FIG. 3 to a deployed state with one or more walls, e.g., similar to FIGS. 1D and 2. More specifically and as shown in FIG. 3 pad 300 may be transitioned to a deployed state by executing folding operations F1, F2, F3, and F4, which may be performed in any order. Specifically, a first fold F1 may be performed on pad 300 by pulling the top outer edge 105 towards the absorbent region 101 and folding a first portion of the border region 103 along and across a first folding axis A-A that extends at least substantially parallel to first reinforcement 109. During the first fold F1, fifth and eighth end portions 305, 313 are deformed (bent) vertically upwards relative to the horizontal absorbent region 101 to form corresponding uprights (i.e. transverse to the longitudinal axis and the body portions of the reinforcement 301, 309 respectively), and a first crease 127 may be formed along the first folding axis A-A, i.e., at least substantially along first reinforcement 109. Following the first fold F1, the horizontal portion of border region 103 including top outer edge 105 may extend vertically upwards relative to the horizontal absorbent region 101 to form a first wall 137.

Before or after the first fold F1, a second fold F2 may be performed by pulling bottom outer edge 111 towards the absorbent region 101 and folding a second portion of the border region 103 along and across a second folding axis B-B that extends at least substantially parallel to second reinforcement 115. During the second fold F2, sixth and seventh end portions 307, 311 are deformed (bent) vertically upwards relative to the horizontal absorbent region 101 to form corresponding uprights, and a second crease 129 may be formed along the second folding axis B-B, i.e., at least substantially along second reinforcement 115. Following the second fold F2, the horizontal portion of border region 103 including bottom outer edge 111 may extend vertically upwards relative to the horizontal absorbent region 101 to form a second wall 139.

Before or after the first fold F1 and second fold F2, a third fold F3 may be performed by pulling left outer edge 121 towards the absorbent region 101 and folding a third portion of the border region 103 along and across a third folding axis C-C that extends at least substantially parallel to fourth reinforcement 309. During the third fold F3, first and third end portions 108, 114 are deformed (bent) vertically upwards relative to absorbent region 101 to form corresponding uprights, and a third crease 131 may be formed along the third folding axis C-C, i.e., at least substantially along fourth reinforcement 309. Following the third fold F3, the horizontal portion of border region 103 including left outer edge 121 may extend vertically upwards relative to the horizontal absorbent region 101 to form a third wall 141.

Before or after the first, second, and/or third folds, a fourth fold F4 may be performed by pulling right outer edge 117 towards the absorbent region 101 and folding a fourth portion of the border region 103 along and across a fourth folding axis D-D that extends at least substantially parallel to third reinforcement 301. During the fourth fold F4, first and third end portions 110, 116 are deformed (bent) vertically upwards relative to absorbent region 101 to form corresponding uprights, and a fourth crease 133 may be formed along the fourth folding axis D-D, i.e., at least substantially along third reinforcement 301. Following the fourth fold F4, the horizontal portion of border region 103 including right outer edge 117 may extend vertically upwards relative to the horizontal absorbent region 101 to form a fourth wall 143.

In the embodiment of FIG. 3 the first-fourth folding axes A-A, B-B, C-C, D-D are at least substantially parallel to one of the first-fourth reinforcements 109, 115, 301, 309. Such a configuration is not required, and the first-fourth folding axes A-A, B-B, C-C, D-D may be positioned differently, resulting in a corresponding difference in the position of a folded edge/crease 127, 129, 131, 133 following execution of the first, second, third, and/or fourth folds F1, F2, F2, and F4 as noted above in connection with pad 100. Like pad 100 the position of the first-fourth folding axes in pad 300 can affect various characteristics of the first-fourth walls, such as but not limited to their height and ability to remain upright relative to absorbent region 101. Accordingly, the position of the first-fourth folding axes A-A, B-B, C-C, D-D and the performance of corresponding first, second, third, and fourth folding operations with pad 300 may be tailored to obtain first-fourth walls 137, 139, 141, 143 with desired characteristics.

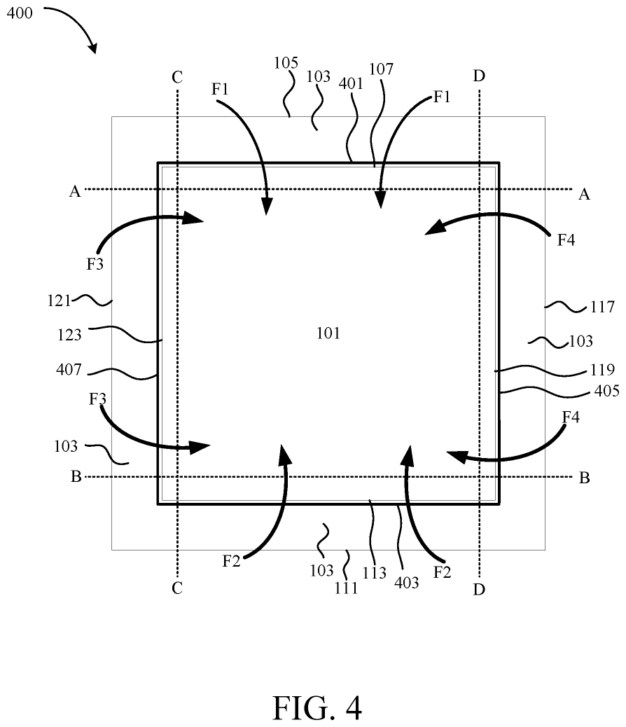

FIG. 4 depicts another example of a pad consistent with the present disclosure. Pad 400 includes many of the same elements as pads 100, 300, and so such elements are not described again in detail in the interest of brevity. Pad 400 principally differs from pad 300 in that it includes first, second, third, and fourth reinforcements 401, 403, 405, 407 that either do not include end portions (i.e., portions that extend past a corner 125 of absorbent region 101) or which include relatively short end portions (i.e., portions that extend only a short distance, e.g., less than about 0.2 inches (e.g., about 5 mm) past a corner 125 of absorbent region 101. Otherwise, the nature and function of reinforcements 401, 403, 405, 407 is the same as described above in connection with reinforcements 109, 115, 301, and 309. Like pads 100 and 300, pad 400 may be initially provided in a substantially flat state, as shown in FIG. 4. And like pads 100 and 300, pad 400 may be transitioned to a deployed state by performing one or more folding operations. More specifically and as shown in FIG. 4, pad 400 may be transitioned to a deployed state by executing folding operations F1, F2, F3, and F4, which may be performed in any order. More particularly, a first fold F1 may be performed on pad 400 by pulling the top outer edge 105 towards the absorbent region 101 and folding a first portion of the border region 103 along and across a first folding axis A-A that extends at least substantially parallel to first reinforcement 401 and over at least a portion of absorbent region 101 that is inward of top inner edge 107. During the first fold F1, a portion of the third and fourth reinforcements 405, 407 proximate top inner edge 107 are deformed (bent) upwards relative to the horizontal absorbent region 101 to form corresponding uprights, and a first crease 127 may be formed along the first folding axis A-A. Following the first fold F1, the horizontal portion of border region 103 including top outer edge 105 may extend vertically upwards relative to the horizontal absorbent region 101 to form a first wall 137. Before or after the first fold F1, a second fold F2 may be performed by pulling bottom outer edge 111 towards the absorbent region 101 and folding a second portion of the border 103 along and across a second folding axis B-B that extends at least substantially parallel to second reinforcement 403 and over at least a portion of absorbent region 101 that is inward of bottom inner edge 113. During the second fold F2, a portion of the third and fourth reinforcements 405, 407 proximate bottom inner edge 113 are deformed (bent) upwards relative to the horizontal absorbent region 101 to form corresponding uprights, and a second crease 129 may be formed along the second folding axis B-B. Following the second fold F2, the horizontal portion of border region 103 including bottom outer edge 111 may extend vertically upwards relative to the horizontal absorbent region 101 to form a second wall 139.

Before or after the first fold F1 and second fold F2, a third fold F3 may be performed by pulling left outer edge 121 towards the absorbent region 101 and folding a third portion of the border 103 along and across a third folding axis C-C that extends at least substantially parallel to fourth reinforcement 407 and over a portion of absorbent region 101 that is inward of left inner edge 123. During the third fold F3, portions of the first and second reinforcements 401, 403 proximate left inner edge 123 are deformed (bent) upwards relative to the horizontal absorbent region 101 to form corresponding uprights, and a third crease 131 may be formed along the third folding axis C-C. Following the third fold F3, the portion of border region 103 including left outer edge 121 may extend upwards relative to absorbent region 101 to form a third wall.

Before or after the first, second, and/or third folds, a fourth fold F4 may be performed by pulling right outer edge 117 towards the absorbent region 101 along and across a fourth folding axis D-D that extends at least substantially parallel to third reinforcement 405 and over a portion of absorbent region 101 that is inward of right inner edge 119. During the fourth fold F4, portions of the first and second reinforcements 401, 403 proximate right inner edge 119 are bent upwards relative to absorbent region 101 to form corresponding uprights, and a fourth crease may be formed along the fourth folding axis D-D. Following the fourth fold F4, the horizontal portion of border region 103 including right outer edge 117 may extend vertically upwards relative to the horizontal absorbent region 101 to form a fourth wall 143.

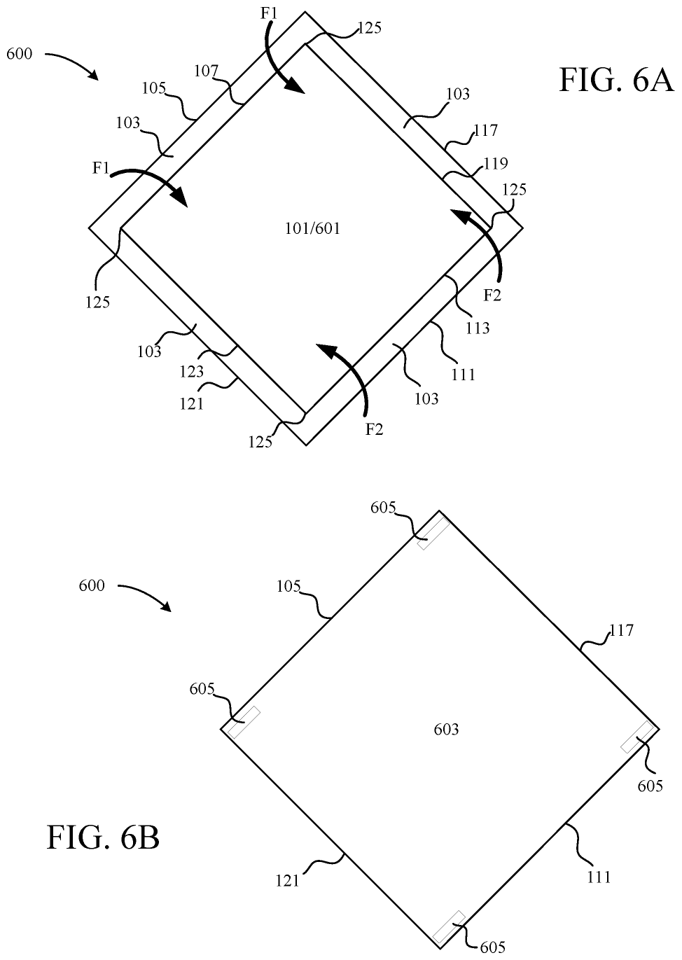

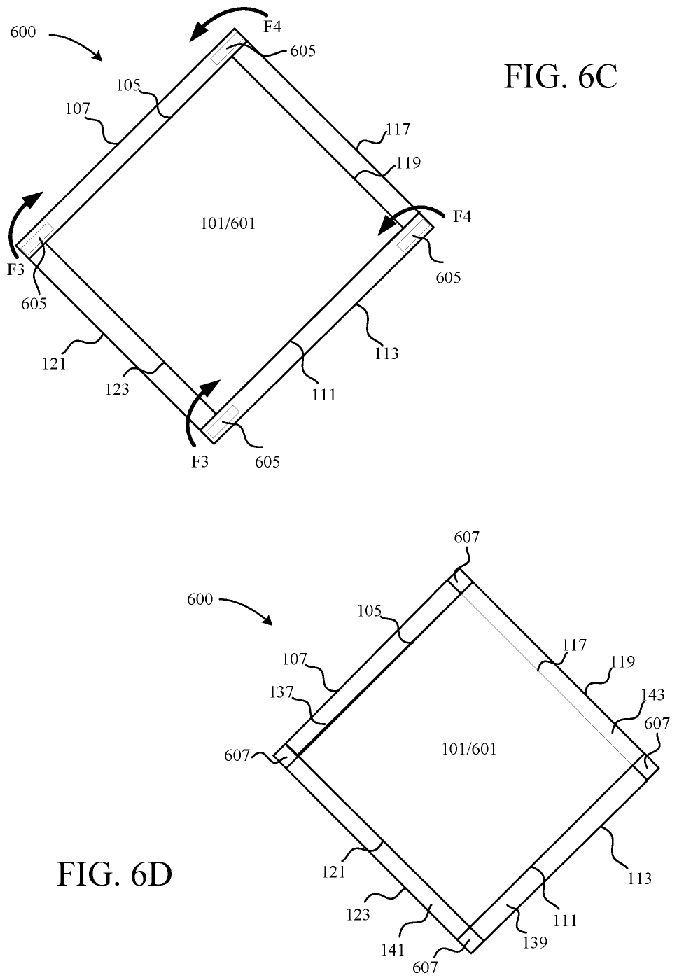

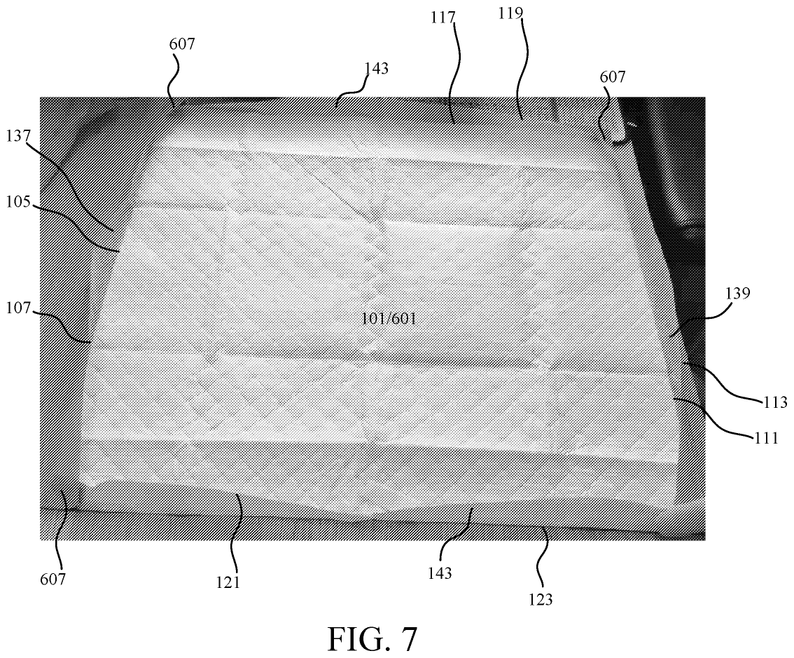

FIGS. 6A-6D and 7 depict another example of a pad consistent with the present disclosure. Pad 600 includes many of the same elements as pads 100, 300, 400, and so such elements are not described again in detail in the interest of brevity. Pad 600 principally differs from pads 100, 300, and 400 in that it does not include reinforcements in the form of wires (such as reinforcements 109, 115, 301, 309, 401, 403, 405, 407. Rather, pad 600 includes a front side 601, a back side 603, and one or more adhesive members 605. As will be discussed below, the adhesive members 605 may be converted into supports 607 by one or more folding operations, wherein the support(s) 607 cause at least one of the border regions 103 to extend upwards to form one or more walls 137, 139, 141, 143.

In the embodiment of FIGS. 6A-6F, pad 600 is depicted as having an overall polygonal, and more particularly a quadrilateral shape and as including a quadrilateral absorbent region 101 continuously surrounded (i.e. 360 degrees) by a “picture (annular) frame” border region 103. However, the pads 600 described herein are not limited to such a configuration, and may have any suitable shape. For example, pad 600 may have an overall shape that has any suitable number of sides, such as 1, 2, 3, 4, 5, 6, 7, 8, 9, 10 or more sides. Likewise, absorbent region 101 may have any suitable number of sides, and in one or more embodiments absorbent region 101 has a number of sides that is the same as or different from the number of sides of pad 600. Preferably, absorbent region 101 has the same number of sides as pad 100, wherein the sides of pad 100 are defined by outer edges of border region 103. Like pads 100, 300, 400, pad 600 may be initially provided in a substantially flat state, as shown in FIGS. 6A and 6B. As best shown in FIG. 6A and 6B, in the substantially flat state pad 600 has a front side 601 and a back side 603. In embodiments and as shown, front side 601 may be on the same side of pad 600 as absorbent region 101 (e.g., an exposed portion of top sheet layer 51 in FIG. 5), and the back side 603 may be opposite front side 601 (e.g., the side of PE film layer 56 facing away from tissue layer 55 and/or the fluid impervious backing layer forming part of border region 103). In this embodiment, one or more adhesive members 605 are disposed on the back side 603 of pad 601, as best shown in FIG. 6B.

The number, nature, and configuration of the adhesive members 605 are not limited, and any suitable number and configuration of adhesive members may be used. In the embodiment of FIGS. 6A-6D, adhesive members 605 are in the form of four polygonal (rectangular) adhesive strips, but that number and configuration is not required. Indeed, in embodiments the number of adhesive members is 1, 2, 3, 4, 5, 6, 7, 8, 9, 10, or more, and such members may have a geometric (e.g., linear, triangular, quadrilateral, pentagonal, hexagonal, etc.) or irregular (e.g. curved, curvilinear, etc.) shape. Without limitation, adhesive members 600 are preferably in the form double sided tape that has a geometric (circular, triangular, quadrilateral, etc.) or irregular shape.

The position of adhesive members 605 is not limited, and such members 605 may be positioned at any suitable location that enables them to form a support following one or more folding operations. In the embodiment of FIGS., 6A-6D and as best shown in FIGS. 6A and 6B, adhesive members 605 are in the form of strips that are each positioned relative to a respective corner 125 of absorbent region 101. For example, adhesive members 605 may be in the form of rectangular strips that have a mid-point that is generally aligned with a respective one of the corners 125 of absorbent region 101. In such embodiments the adhesive members 605 may extend along (e.g., parallel) to the inner edge 107, 113 and outer edge 105, 111 of border regions 103. Of course, such a configuration is not required and adhesive members 605 may be positioned and configured differently, e.g., depending on the configuration of border region 103 and/or absorbent region 101. In any case, the adhesive members 605 may be positioned and configured such that they are foldable to form at least one support that supports at least a portion of a border region 103 to extend upwards relative to absorbent region 101.

Like pads 100, 300, 400, pad 600 may be transitioned to a deployed state by performing one or more folding operations. More specifically and as best shown in FIGS. 6A and 6C, pad 600 may be transitioned to a deployed state by executing folding operations F1, F2, followed by folding operations F3 and F4.

Specifically, a first fold F1 may be performed on pad 600 by pulling the top outer edge 105 towards the absorbent region 101 and folding a first portion of the border region 103 along and across a first folding axis A-A that extends at least substantially parallel to the top inner edge 107. At the same or different time, a second fold F2 may be performed on pad 600 by pulling the bottom outer edge 111 towards the absorbent region 101 and folding a second portion of the border region 103 along and across a second folding axis B-B that extends at least substantially parallel to the bottom inner edge 113. Following the first fold F1 and the second fold F2, adhesive members 605 are reoriented to face upwards relative to absorbent region 101, as best shown in FIG. 6C.

After the first fold F1 and second fold F2, third and fourth folding operations F3, F4 may be performed. The third fold F3 may be performed by pulling left outer edge 121 towards the absorbent region 101 and folding a third portion of the border region 103 along and across a third folding axis C-C that extends at least substantially parallel to the left inner edge 123. Likewise, the fourth fold F4 may be performed by pulling right outer edge 117 towards the absorbent region 101 and folding a fourth portion of the border region 103 along and across a fourth folding axis that extends at least substantially parallel to the right inner edge 119. During the third fold F3, adhesive members 605 proximate left outer edge 121 are folded upon themselves, such that a first portion of each adhesive member 605 contacts and adheres to a second portion of (the same) adhesive member 605. Likewise, during the fourth fold F4, adhesive members 605 proximate right outer edge 117 are folded upon themselves, such that a first portion of each adhesive members 605 contacts and adhesive to a second portion of (the same) adhesive member 605. Thus, following the third and/or fourth folding operations, adhesive members 605 are converted into supports that cause at least a portion of one or more of the border regions 103 to extend upwards at an angle relative to absorbent region 101, thus forming a wall. That is, in the substantially flat state shown in FIGS. 6A and 6B, border regions 103 may extend generally along and/or parallel to a plane that extends parallel to and through absorbent region 101. Following the third and fourth folding operations F3, F4, the border regions 103 may extend upwards relative to the plane that extends parallel to and through absorbent region 101, resulting in the formation of first, second, third, and fourth walls 137, 139, 141, 143, respectively, as best shown in FIG. 6D.

FIG. 7 is a photograph of one example of a pad 600 in the deployed state. As shown, pad 600 includes first, second, third, and fourth walls 137, 139, 141, 143 that can remain upright relative to absorbent region 101 following the performance of folding operations F1, F2, F3, and F4 described above in connection with FIGS. 6A-6C.

In addition, preferably, border region 103 may have a construction that promotes the stability of the border region 103 to effectively act as a border to assist in containing fluid (urine) that may be absorbed by the absorbent region 101. Preferably, the border region 103 therefore may itself comprise only three layers, including a film layer, a paper layer and a top sheet comprising a perforated tissue paper layer. The paper layer may preferably comprise paper have a basis weight in the range of 10 lb. to 40 lb. which is reference to a basis weight of 37.5 gsm to 150 gsm.

Accordingly, in broad context, the present disclosure relates to pet training pads that include one or more reinforcements, and can be initially provided in a substantially flat condition. The pads are configured to transition to a deployed condition by the execution of one or more folding operations that bend the reinforcement(s) to form one or more uprights. By deforming (bending) the reinforcements to form uprights, one or more border regions of the pad are moved to form side (vertical) walls that extend vertically upwards relative to a horizontal absorbent region of the pad. Such side (vertical) walls can function to block the flow of animal waste off of the pad, thereby better containing the animal waste within the physical confines of the pad.

As used herein the term “at least substantially parallel” means parallel or within about +/−10 degrees of parallel.

As used herein the term about when used in connection number or a range, means +/−10% (e.g., +/−5%) of the indicated number or endpoints of the indicated range.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

While the present disclosure has been described in detail for the preferred embodiments described above, it will be understood that modifications can be made without departing from the scope of the disclosure herein.

### LIST OF REFERENCE CHARACTERS

51 top sheet layer
52 attractant layer
53 absorbent layer
54 pulp layer
55 tissue layer
56 film layer
100 pad
101 absorbent region
102 pad body
103 border region
105 border region top outer edge
107 border region top inner edge
108 reinforcement end portion
109 reinforcement
110 reinforcement end portion
111 border region bottom outer edge
113 border region bottom inner edge
114 reinforcement end portion
115 reinforcement
116 reinforcement end portion
117 border region right outer edge
119 border region right inner edge
121 border region left outer edge
123 border region left inner edge
125 corner
127 crease
129 crease
131 crease
133 crease
135 upright
137 wall
139 wall
141 wall
143 wall
300 pad
301 reinforcement
309 reinforcement
305 reinforcement end portion
307 reinforcement end portion
311 reinforcement end portion
313 reinforcement end portion
400 pad
401 reinforcement
403 reinforcement
405 reinforcement
407 reinforcement
600 pad
601 front side
603 back side
605 adhesive members
607 supports
D1 distance
D2 distance
D3 distance
D4 distance
F1 fold
F2 fold
F3 fold
F4 fold

What is claimed is:

1. A pet training pad, comprising:
an absorbent region comprising a first corner, a second corner, a third corner, and a fourth corner;
a border region surrounding the absorbent region, the border region comprising at least a top outer edge, a top inner edge, a bottom outer edge, and a bottom inner edge, the top and bottom inner edges each defined at least in part by respective first and second interfaces between the border region and the absorbent region;
a first reinforcement disposed within the border region and extending at least substantially parallel to the top inner edge, the first reinforcement comprising a first body portion and at least one end portion that extends to or past one of the first and second corners of the absorbent region; and
a second reinforcement disposed within the border region and extending at least substantially parallel to the bottom inner edge, the second reinforcement comprising a second body portion and at least one end portion that extends to or past one of the third and fourth corners of the absorbent region.

2. The pet training pad of claim 1, wherein the first reinforcement comprises first and second end portions, the first end portion extending past the first corner by a first length, the second end portion extending past the second corner by a second length.

3. The pet training pad of claim 2, wherein the second reinforcement comprises third and fourth end portions, the third end portion extending past the third corner by a third length, the fourth end portion extending past the fourth corner by a fourth length.

4. The pet training pad of claim 1, wherein:
the border region further comprises a left inner edge and a right inner edge, the left and right inner edges each defined at least in part by respective third and fourth interfaces between the border region and the absorbent region; and
the pet training pad further comprises:
a third reinforcement disposed within the border region and extending at least substantially parallel to the left inner edge, the third reinforcement comprising a third body portion and at least one end portion that extends to or past one of the first and third corners; and
a fourth reinforcement disposed within the border region and extending at least substantially parallel to the right inner edge, the fourth reinforcement comprising a fourth body portion and at least one end portion that extends to or past one of the second and fourth corners.

5. The pet training pad of claim 4, wherein the first reinforcement comprises first and second end portions, the first end portion extending past the first corner by a first length, the second end portion extending past the second corner by a second length.

6. The pet training pad of claim 5, wherein the second reinforcement comprises third and fourth end portions, the third end portion extending past the third corner by a third length, the fourth end portion extending past the fourth corner by a fourth length.

7. The pet training pad of claim 6, wherein the third reinforcement comprises fifth and sixth end portions, the fifth end portion extending past the first corner by a fifth length, the sixth end portion extending past the third corner by a sixth length.

8. The pet training pad of claim 7, wherein the fourth reinforcement comprises seventh and eighth end portions, the seventh end portion extending past the second corner by a seventh length, the eighth end portion extending past the fourth corner by an eighth length.

9. The pet training pad of claim 4, wherein the end portions of the first, second, third, and fourth reinforcements each extend past one of the first, second, third, and fourth corners of the absorbent region by a length that is less than 1.0 inches.

10. A pet training pad, comprising:
an absorbent region; and
a border region surrounding at least a portion of the absorbent region including a deformable reinforcement disposed within the border region;
wherein the border region including the deformable reinforcement is convertible from a substantially flat configuration to an upright configuration such that the border region including the deformable reinforcement converts from the substantially flat configuration to the upright configuration; and
wherein, when the border region including the deformable reinforcement converts from the substantially flat configuration to the upright configuration, the deformable reinforcement bends from the substantially flat configuration to the upright configuration and the border region forms an upright wall.

11. A pet training pad having a front side and a back side opposite the front side, the pet training pad comprising:
an absorbent region;
a border region surrounding the absorbent region, the border region comprising at least one inner edge defined at least in part by an interface between the border region and the absorbent region;
at least one adhesive member disposed on the back side of the pet training pad, wherein the adhesive member is foldable to form at least a portion of a support that causes at least a portion of the border region to extend upwards relative to the absorbent region.
